(19) United States
(12) Patent Application Publication
(10) Pub. No.: US 2022/0399738 A1
(43) Pub. Date: Dec. 15, 2022

(54) POWER SUPPLY DEVICE, METHOD, AND PROGRAM BASED ON POWER STANDARD ANALYSIS OF CONNECTED ELECTRONIC DEVICE

(71) Applicant: BRONINE CO., LTD., Seoul (KR)

(72) Inventor: Sunhwi MYUNG, Seoul (KR)

(73) Assignee: BRONINE CO., LTD., Seoul (KR)

(21) Appl. No.: 17/821,360

(22) Filed: Aug. 22, 2022

Related U.S. Application Data
(63) Continuation of application No. PCT/KR2021/011418, filed on Aug. 26, 2021.

(30) Foreign Application Priority Data
Oct. 19, 2020 (KR) 10-2020-0135141
Aug. 26, 2021 (KR) 10-2021-0112754

(51) Int. Cl. H02J 7/00

(52) U.S. Cl. CPC H02J 7/00714; H02J 7/0042; H02J 7/0047; H02J 7/00047; H01R 31/06

(57) ABSTRACT

Disclosed is a power supply device including a supply mode determination unit that determines an executable mode among a battery charging mode and a constant power supply mode based on power supplied from a power supply, an output terminal electrically connected to an electronic device, an output type analysis unit that receives a power supply type and a power supply standard of the electronic device from the electronic device, and a transformer unit that transforms the power supplied from the power supply based on the determined power supply type and the determined power supply standard and transmits the transformed power to the electronic device.

### CROSS-REFERENCE TO RELATED APPLICATIONS

The present application is a continuation of International Patent Application No. PCT/KR2021/011418, filed on Aug. 26, 2021, which is based upon and claims the benefit of priority to Korean Patent Application Nos. 10-2020-0135141 filed on Oct. 19, 2020 and 10-2021-0112754 filed on Aug. 26, 2021. The disclosures of the above-listed applications are hereby incorporated by reference herein in their entirety.

### BACKGROUND

Embodiments of the inventive concept described herein relate to a power supply device, method, and program based on power standard analysis of a connected electronic device, and more particularly, relate to a power supply system that may recognize the connected electronic device, may supply battery charging power or driving power, may identify a standard voltage of the connected electronic device, and may supply power at the identified standard voltage.

With the development of electronic products, various types of electronic products are used in real life. The electronic products may be roughly divided into wireless electronic products and wired electronic products.

The wireless electronic products may include a separate power supply device such as a battery therein, and may be driven by receiving power from an internal power supply device. A lithium ion (Li-ion) battery, a nickel hydride (Ni-MH) battery, or the like is used as such the battery. The standard voltage required for charging is different depending on the type and capacity of a battery. Moreover, the maximum amount of allowed current is different as long as no damage occurs. Accordingly, a dedicated charger is separately used for each electronic product.

Furthermore, the wired electronic products receive driving power from a power source (e.g., an outlet, or the like) through a power supply cable. Because a voltage and current required for each electronic product are different, a dedicated power supply cable for each electronic product is used.

While a lot of chargers and power supply cables are produced, a consumer's burden of separately purchasing them, a cost required to discard them, and environmental pollution caused by discarding them may increase.

Moreover, even when a voltage and a current, which are capable of being supplied, are within an allowable range, it is difficult to be interchangeable with each other because terminals and terminal types to be connected are different from one another, users need to own all chargers and power supply cables separately.

Besides, terminals and terminal types are the same as each other although the voltage and the current, which are capable of being supplied, are different from each other, and thus users may interchangeably employ the terminals or the terminal types. In this case, electronic products or batteries of the electronic products may be damaged.

### SUMMARY

Embodiments of the inventive concept provide a power supply device, method, and program that may display, to a user, a mode, which is capable of being executed, from among a battery charging mode and a constant power supply mode based on power supplied from a power source.

Furthermore, embodiments of the inventive concept provide a power supply device, method, and program that may automatically analyze an electronic product when being connected to the electronic product, may supply appropriate power to a battery when the electronic product is operated based on the battery, and may supply standard power to the electronic product when the electronic product is driven based on constant power.

Moreover, embodiments of the inventive concept provide a power supply device, method, and program that may convert and supply power supplied from a USB terminal, which is used conventionally commonly, or a terminal used in a power delivery (PD) method, or a quick charge (QC) method into power capable of charging or driving the connected electronic product.

Besides, embodiments of the inventive concept provide a power supply device, method, and program that may convert and supply power supplied from a general power supply into power capable of charging or driving the connected electronic product.

Also, embodiments of the inventive concept provide a power supply device, method, and program that may be formed such that a terminal part of a connection line is detachably from various types of terminals, and may be used in combination with terminals of different types used conventionally.

Problems to be solved by the inventive concept are not limited to the problems mentioned above, and other problems not mentioned will be clearly understood by those skilled in the art from the following description.

According to an embodiment, a power supply device includes a supply mode determination unit that determines an executable mode among a battery charging mode and a constant power supply mode based on power supplied from a power supply, an output terminal electrically connected to an electronic device, an output type analysis unit that receives a power supply type and a power supply standard of the electronic device from the electronic device, and a transformer unit that transforms the power supplied from the power supply based on the determined power supply type and the determined power supply standard and transmits the transformed power to the electronic device.

Moreover, the supply mode determination unit may determine the battery charging mode and the constant power supply mode as the executable mode when the power supplied from the power supply is greater than predetermined reference power, and determines only the battery charging mode as the executable mode when the power supplied from the power supply is smaller than the predetermined reference power.

Besides, when the electronic device is in a battery type, the power supply standard of the electronic device may include a standard voltage. The transformer unit may transmit battery charging power having the standard voltage and a battery supply current calculated based on the standard voltage, through the output terminal.

According to an embodiment, a power supply method performed by a power supply device connected to a power supply includes determining, by the power supply device, an executable mode among a battery charging mode and a constant power supply mode based on power supplied from the power supply, connecting, by the power supply device, to an electronic device, receiving, by the power supply device, a power supply type and a power supply standard of the electronic device from the electronic device, and transforming, by the power supply device, the power supplied from the power supply based on the power supply type and the power supply standard and transmitting the transformed power to the electronic device.

Moreover, the determining of the executable mode may include determining the battery charging mode and the constant power supply mode as the executable mode when the power supplied from the power supply is greater than predetermined reference power and determining only the battery charging mode as the executable mode when the power supplied from the power supply is smaller than the predetermined reference power.

In addition, another method and another system for implementing the inventive concept, and a computer-readable recording medium for recording a computer program for performing the method may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a perspective view illustrating a configuration of a system including a power supply device, according to an embodiment of the inventive concept;

FIG. 2 is a perspective view illustrating a free-voltage charger, a free-voltage adapter, and a free-voltage battery, which are power supply devices, according to an embodiment of the inventive concept;

FIG. 3 is a conceptual diagram illustrating that a power supply device is connected to an electronic device, according to an embodiment of the inventive concept;

FIG. 4 is a block diagram illustrating a configuration of a free-voltage charger according to FIG. 1;

FIG. 5 is a conceptual diagram illustrating an operation process of a power supply device, according to an embodiment of the inventive concept;

FIG. 6 is a block diagram illustrating a configuration of a free-voltage terminal according to FIG. 1;

FIG. 7 is a block diagram illustrating a configuration of a free-voltage adapter according to FIG. 2;

FIG. 8 is a block diagram illustrating a configuration of a free-voltage battery according to FIG. 2;

FIG. 9 is a flowchart illustrating a process of a power supply method, according to an embodiment of the inventive concept;

FIG. 10 is a flowchart illustrating a process of an embodiment of operation S20 of FIG. 9;

FIG. 11 is a flowchart illustrating a process of another embodiment of operation S20 of FIG. 9;

FIG. 12 is a flowchart illustrating a process of operation S40 of FIG. 9; and

FIG. 13 is a flowchart illustrating a process of operation S60 of FIG. 9.

### DETAILED DESCRIPTION

The above and other aspects, features and advantages of the inventive concept will become apparent from embodiments to be described in detail in conjunction with the accompanying drawings. The inventive concept, however, may be embodied in various different forms, and should not be construed as being limited only to the illustrated embodiments. Rather, these embodiments are provided as examples so that the inventive concept will be thorough and complete, and will fully convey the scope of the inventive concept to those skilled in the art. The inventive concept may be defined by the scope of the claims.

The terms used herein are provided to describe embodiments, not intended to limit the inventive concept. In the specification, the singular forms include plural forms unless particularly mentioned. The terms “comprises” and/or “comprising” used herein do not exclude the presence or addition of one or more other components, in addition to the aforementioned components. The same reference numerals denote the same components throughout the specification. As used herein, the term “and/or” includes each of the associated components and all combinations of one or more of the associated components. It will be understood that, although the terms “first”, “second”, etc., may be used herein to describe various components, these components should not be limited by these terms. These terms are only used to distinguish one component from another component. Thus, a first component that is discussed below could be termed a second component without departing from the technical idea of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

A term “electronic device” used hereinafter refers to devices capable of being driven or charged through power. For example, the electronic device may include a digital camera, a smart phone, a notebook computer, a tablet PC, a wireless cleaner, a hair beauty appliance, an electric tool, an electric shaver, a drone, or a battery thereof.

Hereinafter, an embodiment of the inventive concept will be described in detail with reference to the accompanying drawings.

Prior to a description, the meaning of terms used in the present specification will be described briefly. However, because the description of terms is used to help the understanding of this specification, it should be noted that if the inventive concept is not explicitly described as a limiting matter, it is not used in the sense of limiting the technical idea of the inventive concept.

1. Description of Configuration of Power Supply System According to Embodiment of Inventive Concept

The power supply system according to an embodiment of the inventive concept includes a power supply device, an extension cable 510, a connection gender 520, and a series-type connection kit 530. The power supply device may include a free-voltage charger 100, a free-voltage adapter 200, and a free-voltage battery 300.

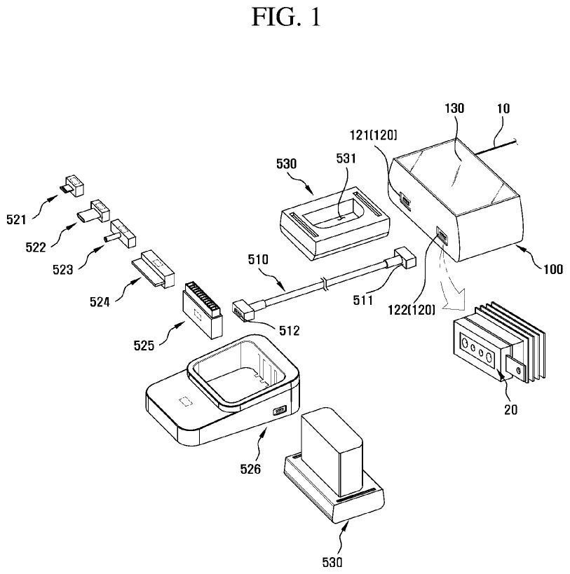

Referring to FIG. 1, the free-voltage charger 100, the extension cable 510, the connection gender 520 and the series-type connection kit 530 are illustrated.

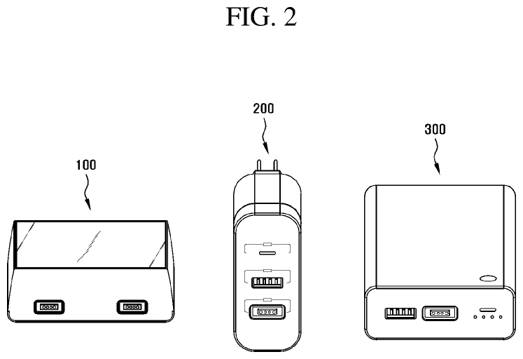

Referring to FIG. 2, the free-voltage charger 100, the free-voltage adapter 200, and the free-voltage battery 300 are illustrated.

Returning to FIG. 1, the free-voltage charger 100 includes a power supply connection terminal (not shown) and an output terminal 120.

The power supply connection terminal (not shown) is connected to conventional adapters to receive power from the conventional adapters. The conventional adapters convert alternating current (AC) power of a power source into DC power and supply direct current (DC) power to the free-voltage charger 100. For example, terminals of adapters using a DC method including a conventional PD method, a QC method, or the like may be coupled to a power supply connection terminal. In an embodiment, the conventional adapter terminal may include USB-A type, USB-B type, USB-C type, and the like.

Accordingly, a plurality of power supply connection terminals having different shapes may be formed. In an embodiment not shown, the power supply connection terminal may be formed on the opposite side of the output terminal 120.

In addition, in the DC method such as the PD method or the QC method, levels of voltage and current that are capable of being supplied are formed differently from each other. The free-voltage charger 100 may change a voltage of power supplied from the conventional adapter terminals by increasing or decreasing the voltage depending on the connected electronic device.

For example, when the power input in the PD method corresponds to 3 A at 12 V, the free-voltage charger 100 may supply power to the electronic device through an output terminal 120 by increasing a voltage (more than 12 V) depending on the connected electronic device.

The electronic device is electrically connected to the output terminal 120 through the extension cable 510.

Connection terminals 511 and 512 for electrical connection are formed at opposite ends of the extension cable 510, respectively. The connection terminal 511, which is positioned on the other side of the free-voltage charger 100, from among connection terminals is detachably coupled with the plurality of connection genders 520 having different shapes.

In the illustrated embodiment, the connection genders 520 include a lightning connection gender 521, a C-type connection gender 522, a DC charging connection gender 523, a notebook connection gender 524, a drone connection gender 525, and an electric drill connection gender 526. In an embodiment not shown, the connection genders 520 may be formed in a shape corresponding to terminals of various electronic devices.

That is, each of the connection genders 520 is formed in a shape corresponding to the shape of the terminal formed in the electronic device. For example, when the lightning connection gender 521 is coupled with the connection terminal 511, the lightning connection gender 521 may be connected to an electronic device equipped with a lightning terminal among products manufactured by Apple Inc.

Because the connection gender 520 and the connection terminal 511 are configured to be detachable from each other, power may be supplied by electrically connecting to various electronic devices as long as only the one extension cable 510 and the set of connection genders 520 are provided.

However, it is not limited thereto. For example, the connection terminal 511 and the connection gender 520 may be formed integrally.

In the illustrated embodiment, the connection terminal 511 and the connection gender 520 may be detachably coupled to each other by magnets, and the connection terminal 512 and the output terminal 120 may be detachably coupled to each other by magnets.

The series-type connection kit 530 includes a terminal (not shown) that is electrically connected to the output terminal 120 of the free-voltage charger 100, and an accommodation recess into which a battery is capable of being coupled is formed to be recessed on one side of the terminal.

The accommodation recess accommodates at least part of the battery and is formed to interlock with the part of the battery to be accommodated. Also, with the battery connected, a terminal having a shape corresponding to a charging terminal of the battery is formed in a part, which faces the charging terminal of the battery, from among parts of the accommodation recess. Also, while the battery is connected, the two terminals are in contact with each other.

In this way, a power supply is electrically connected to the battery through a conventional adapter 10, the free-voltage charger 100, and the series-type connection kit 530.

In an embodiment not shown, the series-type connection kit 530 may not be directly connected to the output terminal 120, but may be connected to the output terminal 120 through the extension cable 510.

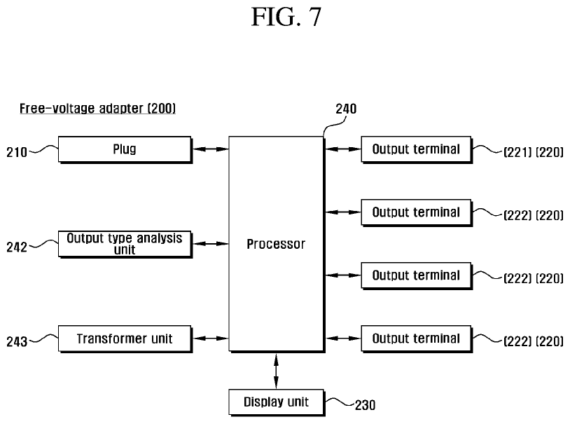

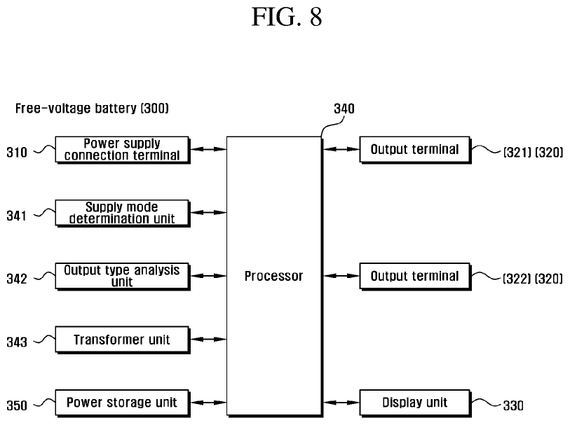

Moreover, referring to FIG. 1, a free-voltage terminal 20 capable of being used in the connection terminals 511 and 512 of the extension cable 510, the output terminal 120 of the free-voltage charger 100, the output terminal 220 (see FIG. 7) of the free-voltage adapter 200, and the output terminal 320 (see FIG. 8) of the free-voltage battery 300 is shown.

A free-voltage terminal 20 includes at least three electrodes spaced from each other. The three electrodes correspond to a positive electrode (+), a negative electrode (−), and a product analysis electrode, respectively. When power is supplied to the electronic device from a power source, the positive electrode and the negative electrode are used as a path through which current flows. Moreover, to identify the characteristics (a battery-based operation, a standard voltage, and a standard current) of an electronic device, the product analysis electrode is used as a path for a microcurrent to be supplied by the free-voltage charger 100, the free-voltage adapter 200, and the free-voltage battery 300.

Furthermore, a data transmission electrode for transmitting data may be included. However, an embodiment is not limited thereto, and four or more electrodes may be used in the free-voltage terminal 20.

Besides, the free-voltage terminal 20 may include a processor for controlling the free-voltage charger 100, the free-voltage adapter 200, and the free-voltage battery 300.

FIG. 1 illustrates a shape of a pogo pin in which the free-voltage terminal 20 includes magnets, but the shape of the free-voltage terminal 20 is not limited thereto. For example, the free-voltage terminal 20 may have a USB-C type shape. The function of the free-voltage terminal 20 is not determined by the shape of a terminal, but is determined by a processor controlling the free-voltage charger 100 including the free-voltage terminal 20, the free-voltage adapter 200 and the free-voltage battery 300.

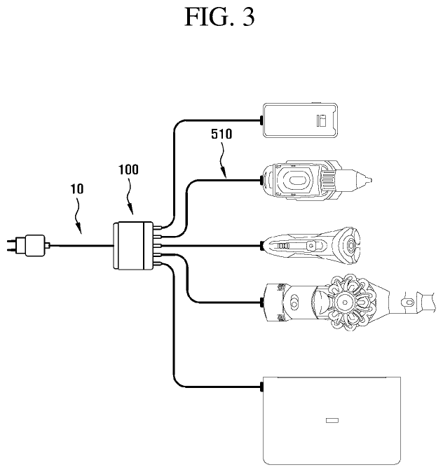

Referring to FIG. 3, the specific voltage and current supplied through the conventional adapter 10 are transformed in the free-voltage charger 100 and then are supplied to each electronic device through the extension cable 510.

That is, the free-voltage charger 100 determines whether each electronic device is in a battery type driven through battery charging and a constant power type driven through a constant power supply, and supplies the transformed power depending on the determined type.

For the battery type, the electronic device may include a battery. The electronic device may include a battery stored therein and may be driven based on the battery.

For the battery type, the free-voltage charger 100 identifies a charging voltage of the electronic device, converts power supplied from a power source into power with a charging voltage, and supplies the converted power to the electronic device. For example, a camera, a drone, or the like may correspond to the battery type.

For the constant power type, the free-voltage charger 100 identifies the standard voltage and standard current of the electronic device, converts power supplied from the power source into power with standard voltage and standard current, and supplies the converted power to the electronic device. For example, a notebook or the like may correspond to the constant power type.

In addition to the free-voltage charger 100, the power converted depending on the type of electronic device connected through the free-voltage adapter 200 and the free-voltage battery 300 may be supplied.

In this way, without a dedicated charger or a dedicated power supply cable, the power supply system according to an embodiment of the inventive concept may supply the power modified depending on the type of each electronic device.

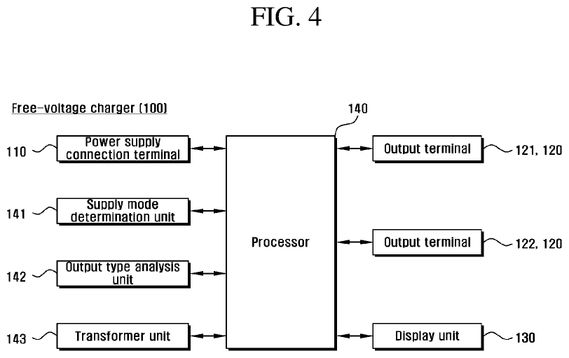

Hereinafter, the above-described configuration of a power supply system will be described in more detail with reference to FIGS. 4 to 6.

Description of Free-Voltage Charger 100

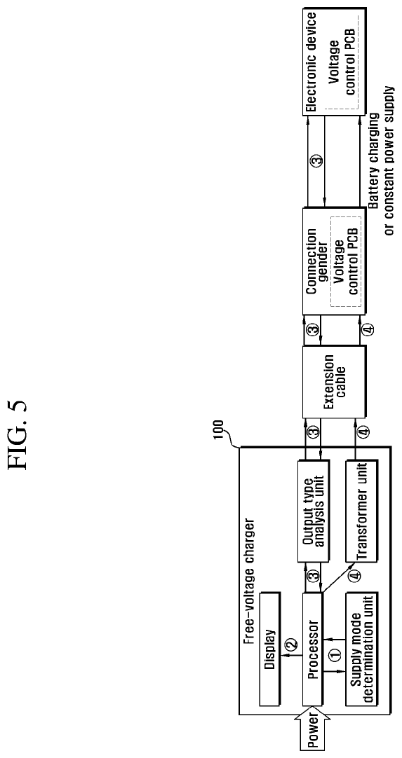

Referring to FIGS. 4 and 5, the free-voltage charger 100 includes a power supply connection terminal 110, an output terminal 120, a display unit 130, a processor 140, a supply mode determination unit 141, an output type analysis unit 142, and a transformer unit 143. Each configuration of the free-voltage charger 100 may be controlled by the processor 140.

In an embodiment not shown, the free-voltage charger 100 may include an LED unit instead of the display unit 130.

The free-voltage charger 100 includes housing that forms an exterior thereof. As shown in FIG. 2, the housing may be formed in a hexahedral shape in which some surfaces are curved. However, an embodiment is not limited thereto, and may be formed in various shapes.

The at least one power supply connection terminal 110 and the at least one output terminal 120 are formed on the outer peripheral surface of the housing.

The power supply connection terminal 110 is formed in a form capable of being coupled with the conventional adapter 10, and the output terminal 120 may be the free-voltage terminal 20.

In an embodiment, all of output terminals 121, 122, and 123 may be the free-voltage terminals 20. Some of the output terminals 121 and 122 may be the free-voltage terminals 20, and the other terminal 123 may be a conventional terminal such as a USB-C type terminal.

However, it is not limited thereto. For example, the four or more output terminals 120 may be provided. In addition, at least one of the output terminals 120 may be implemented as the free-voltage terminal 20, and the others thereof may be implemented as a conventional terminal.

In addition, the display unit 130 is formed on the outer peripheral surface of the housing. The display unit 130 may display the type of a terminal (PD, QC, or the like) connected to the power supply connection terminal 110. Besides, the display unit 130 may display the type (an adapter, an auxiliary battery, or the like) of a device connected to the power supply connection terminal 110.

Also, a mode capable of being executed in the output terminal 120 may be displayed based on power supplied from the connected terminal. The free-voltage charger 100 may provide a battery charging mode and a constant power supply mode through the output terminal 120. The processor 140 allows the supply mode determination unit 141 to determine an executable mode based on the supplied power, and allows the display unit 130 to display the determined mode in a shape that is visually recognizable.

Moreover, the processor 140 allows the display unit 130 to display at least one of a standard voltage of the electronic device connected to the output terminal 120, a voltage/current of power supplied to the connected electronic device, and the degree of charge of the connected battery in the shape that is visually recognizable.

Also, the processor 140 allows the output type analysis unit 142 to supply a microcurrent to the connected electronic device and to determine a power supply type and power supply standard of the corresponding electronic device.

The power supply type is classified into a battery type and a constant power type. When the electronic device is in the battery type, the power supply standard includes information about a charging voltage. For the constant power type, the power supply standard includes information about a standard voltage and standard current.

At least one of the connection gender 520, the series-type connection kit 530, and the electronic device may include a transformer control printed circuit board (PCB). The transformer control PCB includes information about the power supply type and power supply standard of the electronic device.

The processor 140 allows the output type analysis unit 142 to transmit a microcurrent to the voltage control PCB and to identify information about the power supply type and the power supply standard.

The processor 140 allows the transformer unit 143 to convert the power received from a power supply based on the identified power supply type and the power supply standard, and transmit the converted power to the electronic device.

In addition, the processor 140 is accommodated inside the housing, and the processor 140 is electrically connected to each component of the free-voltage charger 100. In an embodiment, the processor 140 may be implemented as a PCB including elements for performing functions of the free-voltage charger 100, or a microcomputer. However, an embodiment is not limited thereto.

In an embodiment, the output terminal 120 of the free-voltage charger 100 may be implemented as the free-voltage terminal 20.

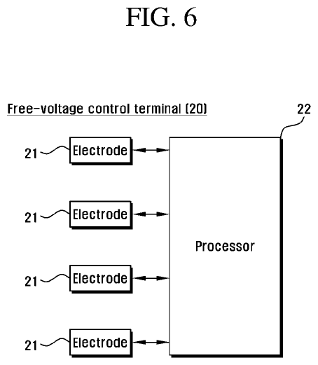

Referring to FIG. 6, a configuration of the free-voltage terminal 20 is shown. The free-voltage terminal 20 may include a plurality of electrodes 21 and a processor 22. A shape of a free-voltage terminal 20 is not limited by FIG. 1. For example, the free-voltage terminal 20 may have a USB-C type shape.

In an embodiment, the processor 140 of the free-voltage charger 100 may be implemented as a processor 22 of the free-voltage terminal 20. In this case, each configuration of the free-voltage charger 100 may be controlled by the processor 22 of the free-voltage terminal 20. The processor 22 may perform at least some functions of the processor 140.

Description of Free-Voltage Adapter 200 and Free-Voltage Battery 300

Referring to FIGS. 7 and 8, the free-voltage adapter 200 and the free-voltage battery 300 are shown.

Compared with the free-voltage charger 100, the free-voltage adapter 200 has following differences.

The free-voltage adapter 200 directly receives AC power from an AC power source (220V or 110V) without receiving DC power from the conventional adapter 10.

An electronic device is connected to a power supply through the free-voltage adapter 200 and the extension cable 510.

The power supply connection terminal 110 is formed in the free-voltage charger 100. On the other hand, the free-voltage adapter 200 has a plug 210, not the power supply connection terminal 110.

The free-voltage adapter 200 is directly coupled to an outlet through the plug 210 to directly receive power from the AC power source (220V or 110V).

That is, the free-voltage adapter 200 reduces and supplies the power received from the AC power source (220V or 110V) so as to be suitable for the charging voltage of the connected battery and the standard voltage of the electronic device.

On the other hand, there is a difference in that the free-voltage charger 100 increases/decreases and supplies the power received through the conventional adapter 10 so as to be suitable for the charging voltage of the connected battery and the standard voltage of the electronic device.

Moreover, because the free-voltage charger 100 receives restricted power from the conventional adapter, the free-voltage charger 100 determines and displays an executable mode. On the other hand, because the free-voltage adapter 200 directly receives power, the free-voltage adapter 200 does not include a supply mode determination unit.

Except for the difference, an output type analysis unit 242, a transformer unit 243, and an output terminal 220 of the free-voltage adapter 200 may be configured to be the same as the output type analysis unit 142, the transformer unit 143, and the output terminal 120 of the free-voltage charger 100.

Also, compared with the free-voltage charger 100, the free-voltage battery 300 has following differences.

Referring to FIG. 8, the free-voltage battery 300 further includes a power storage unit 350.

The free-voltage battery 300 may charge the power storage unit 350 by converting the power supplied through a power supply connection terminal 310 to a charging voltage of the power storage unit 350.

Furthermore, when the free-voltage battery 300 is connected to an electronic device through an output terminal 320, the free-voltage battery 300 supplies power to the electronic device by using the power storage unit 350 as a power source, not an external power supply.

The supply mode determination unit 141, the output type analysis unit 142, the transformer unit 143, and the output terminal 120 of the free-voltage charger 100 analyzes the electronic device by using power thus externally supplied, and supplies the power.

On the other hand, a supply mode determination unit 341, an output type analysis unit 342, a transformer unit 343, and an output terminal 320 of the free-voltage battery 300 analyze the electronic device by using the power storage unit 350 as a power source, and supply the power.

Except for the differences, the supply mode determination unit 341, the output type analysis unit 342, the transformer unit 343, and the output terminal 320 of the free-voltage battery 300 may be configured to be the same as the supply mode determination unit 141, the output type analysis unit 142, the transformer unit 143, and the output terminal 120 of the free-voltage charger 100.

2. Description of Power Supply Method According to Embodiment of Inventive Concept

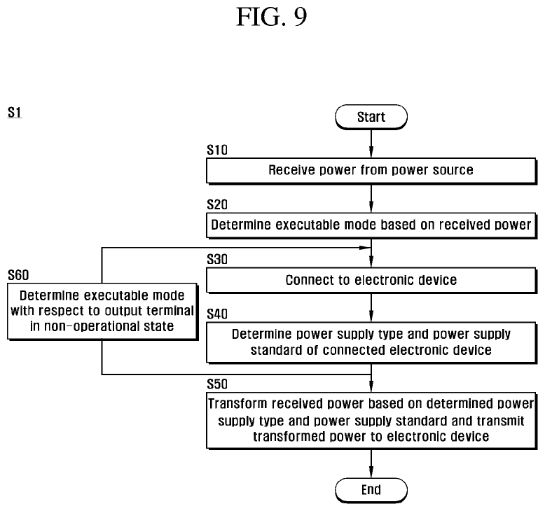

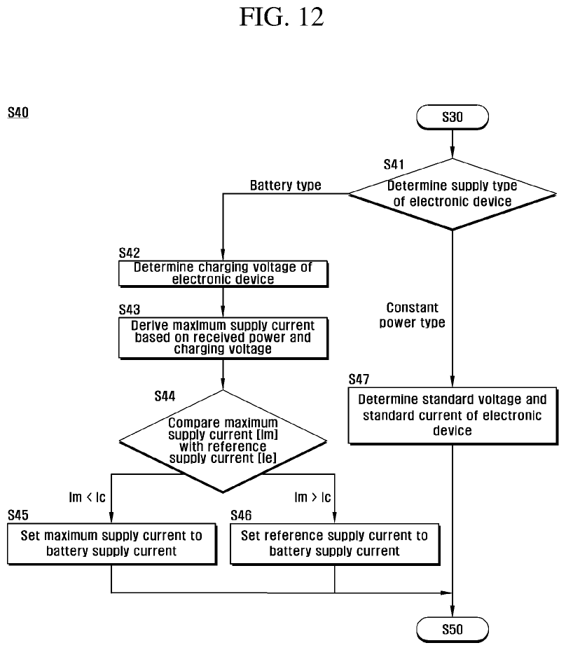

Hereinafter, a power supply method according to an embodiment of the inventive concept will be described with reference to FIGS. 9 to 13.

Referring to FIG. 9, the power supply device 100, 200, or 300 receives power from a power source (S10). The free-voltage charger 100 receives DC power; the free-voltage adapter 200 receives AC power; and, the free-voltage battery 300 receives power from the power storage unit 350 thus embedded therein.

When the power is supplied from the power source, the power supply device 100 or 300 determines an executable mode based on the received power, and displays the determined mode (S20).

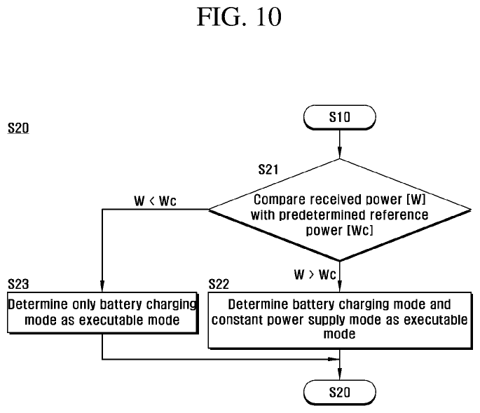

Referring to FIG. 10, an embodiment of operation S20 is illustrated.

The processor 140 or 340 in the power supply device 100 or 300 allows the supply mode determination unit 141 or 341 to compare the power received from the power source with predetermined reference power (S21).

When the reference power is smaller than the received power, the processor 140 or 340 allows the supply mode determination unit 141 or 341 to determine a battery charging mode and a constant power supply mode as the executable mode (S22).

When the reference power is greater than the received power, the processor 140 or 340 allows the supply mode determination unit 141 or 341 to determine only the battery charging mode as the executable mode (S23).

The constant power supply requires power more than battery charging. When the power received from the power source is not sufficient to supply constant power, the constant power supply is restricted, and thus the power supply device 100 or 300 displays a notification of the restriction such that a user is capable of identifying the restriction, by determining the restriction in advance.

For example, the power of 15 W is supplied from a QC-type adapter. On the other hand, when the constant power required to operate the notebook is 40 W, the constant power supply mode may be restricted. On the other hand, when the power of 60 W is supplied from a PD-type adapter, both the battery charging mode and the constant power supply mode may be executed.

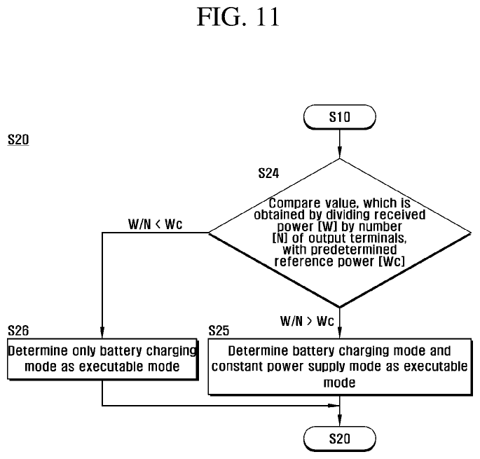

Referring to FIG. 11, another embodiment of operation S20 is illustrated.

The processor 140 or 340 in the power supply device 100 or 300 allows the supply mode determination unit 141 or 341 to compare a value, which is obtained by dividing power received from a power supply by the number of output terminals 120 and 320, with predetermined reference power (S24).

When the reference power is smaller than the value obtained by dividing the received power by the number of output terminals, the processor 140 or 340 allows the supply mode determination unit 141 or 341 to determine that the battery charging mode and constant power supply mode are executable at each output terminal (S25).

When the reference power is greater than the value obtained by dividing the received power by the number of output terminals, the processor 140 or 340 allows the supply mode determination unit 141 or 341 to determine that only the battery charging mode is executable at each output terminal (S26).

There may be the plurality of output terminals 120 and 320. The executable mode may be determined for each output terminal 120 or 320 after the received power is divided and distributed for each output terminal 120 or 320.

However, it is not limited thereto. As in the embodiment described with reference to FIG. 10, the executable mode may be determined regardless of the number of output terminals 120 and 320.

Returning to FIG. 9, the power supply device 100, 200, or 300 connects to an electronic device (S30). The power supply device 100, 200, or 300 may be electrically connected to the electronic device through the extension cable 510. Moreover, the power supply device 100, 200, or 300 may be electrically connected to the electronic device via the connection gender 520 or the series-type connection kit 530 through the extension cable 510, or may be electrically connected to the electronic device via the series-type connection kit 530 without passing through the extension cable 510. Here, the electronic device connected through the extension cable 510 may be a battery. When being connected to the electronic device, the power supply device 100, 200, or 300 determines the power supply type and power supply standard of the connected electronic device (S40).

The processor 140, 240, or 340 allows the output type analysis unit 142, 242, or 342 to determine the power supply type of the corresponding electronic device control by transmitting a microcurrent to the connected electronic device, the connection gender 520, or the series-type connection kit 530 (S41).

When the power supply type is the battery type, the processor 140, 240, or 340 determines the charging voltage of the electronic device through the microcurrent transmitted through the output type analysis unit 142, 242, or 342 (S42). For the battery type, the power supply standard includes information about a charging voltage.

The processor 140, 240, or 340 allows the output type analysis unit 142, 242, or 342 to derive the maximum supply current based on the power received from the power supply and the charging voltage (S43).

In an embodiment, the maximum supply current may be derived by dividing the power received from a power supply by the charging voltage.

Also, in another embodiment, when the power received from the power supply is distributed to each output terminal 120, 220, or 320, the maximum supply current may be derived by dividing a value, which is obtained by dividing the power received from the power supply by the number of terminals, by the charging voltage.

When the maximum supply current is derived, the processor 140, 240, or 340 allows the output type analysis unit 142, 242, or 342 to compare the maximum supply current with a predetermined reference supply current (S44). The predetermined reference supply current may be set to a value for supporting fast charging in a range within which a battery is not damaged.

When the derived maximum supply current is smaller than the reference supply current, the processor 140, 240, or 340 allows the output type analysis unit 142, 242, or 342 to set the maximum supply current to a battery supply current (S45).

When the derived maximum supply current is greater than the reference supply current, the processor 140, 240, or 340 allows the output type analysis unit 142, 242, or 342 to set the reference supply current to a battery supply current (S46).

When the power supply type is the constant power type, the processor 140, 240, or 340 determines the standard voltage and standard current of the electronic device through the microcurrent transmitted through the output type analysis unit 142, 242, or 342 (S47). For the constant power type, the power supply standard includes information about a standard voltage and standard current.

Information about a power supply type and power supply standard may be obtained by analyzing a microcurrent returned to the power supply device 100, 200, or 300 through the transformer control PCB included in at least one of the connection gender 520 or 530 and the electronic device.

Returning to FIG. 9, the power supply device 100, 200, or 300 transforms the received power based on the determined power supply type and power supply standard and transmits the transformed power to the electronic device (S50).

For the battery type, power including a charging voltage and battery supply current is supplied to the electronic device.

For the constant power type, power including the standard voltage and standard current is supplied to the electronic device.

When power is supplied to the electronic device through one of the output terminals 120, 220, and 320, the power supply device 100 or 300 determines and displays the executable mode with respect to the output terminal 120 or 320 in a non-operational state (S60).

For example, when the constant power of 30 W is supplied through the first output terminal 121 or 321 and the power received from a power supply is 50 W, the power supply device 100 or 300 determines and displays the executable mode based on a difference (20 W) between the power of 50 W and the constant power of 30 W.

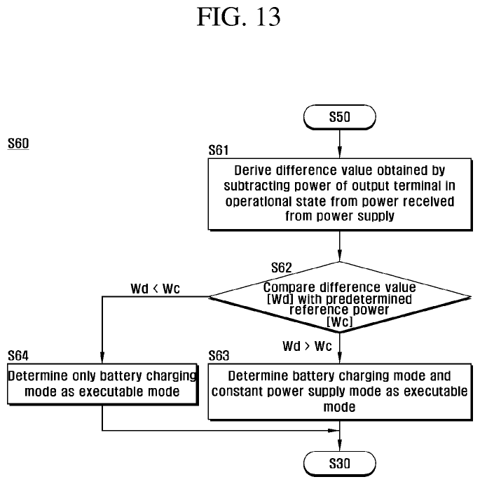

Referring to FIG. 13, the process of operation S60 is illustrated.

First of all, the processor 140 or 340 allows the supply mode determination unit 141 or 341 to derive a difference value obtained by subtracting the power of the output terminal in an operational state from the power received from the power supply (S61).

When the difference value is derived, the processor 140 or 340 allows the supply mode determination unit 141 or 341 to compare the difference value with the predetermined reference power (S62).

When the reference power is smaller than the difference value, the processor 140 or 340 allows the supply mode determination unit 141 or 341 to determine that the battery charging mode and constant power supply mode are executable at an output terminal in a non-operational state (S63).

When the reference power is greater than the difference value, the processor 140 or 340 allows the supply mode determination unit 141 or 341 to determine that only the battery charging mode is executable at an output terminal in a non-operational state (S64).

When the output terminals 120 and 320 are left in the non-operational state, operation S30, operation S40, operation S50, and operation S60 may be performed repeatedly.

According to an embodiment of the inventive concept, because the power supply device analyzes power supplied from a power supply and displays an executable mode among a battery charging mode and a constant power supply mode, a user may select an appropriate electronic device from among a battery-type electronic device and a constant power-type electronic device and may connect to a power supply device.

Moreover, when the electronic device is connected, power suitable for charging or driving may be supplied to the electronic device to which a power supply device is connected.

Besides, the power supply device may convert and supply power supplied from a USB terminal, which is used conventionally commonly, or a terminal used in a PD method, or a QC method into power suitable for driving the connected electronic product.

Also, the power supply device may be formed such that a terminal part of a connection line is detachably from various types of terminals, and may be used in combination with terminals of different types used conventionally.

Furthermore, the user may supply power suitable for various electronic products by using a power supply system according to an embodiment of the inventive concept, thereby improving user convenience and reducing economic burden of the user who needs to purchase a dedicated power supply device for each electronic product. In addition, environmental pollution caused by discarding a lot of dedicated power supply devices may be reduced.

Although an embodiment of the inventive concept are described with reference to the accompanying drawings, it will be understood by those skilled in the art to which the inventive concept pertains that the inventive concept may be carried out in other detailed forms without changing the scope and spirit or the essential features of the inventive concept. Therefore, the embodiments described above are provided by way of example in all aspects, and should be construed not to be restrictive. While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A power supply device comprising:
a supply mode determination unit configured to determine an executable mode among a battery charging mode and a constant power supply mode based on power supplied from a power supply;
an output terminal electrically connected to an electronic device;
an output type analysis unit configured to receive a power supply type and a power supply standard of the electronic device from the electronic device; and
a transformer unit configured to transform the power supplied from the power supply based on the determined power supply type and the determined power supply standard and to transmit the transformed power to the electronic device.

2. The power supply device of claim 1, wherein the supply mode determination unit determines the battery charging mode and the constant power supply mode as the executable mode when the power supplied from the power supply is greater than predetermined reference power, and determines only the battery charging mode as the executable mode when the power supplied from the power supply is smaller than the predetermined reference power.

3. The power supply device of claim 2, wherein the output terminal includes a plurality of output terminals,
wherein the plurality of output terminals are classified into a first output terminal, which is in an operational state that supplies power to the electronic device, and a second output terminal, which is in a non-operational state that does not supply power to the electronic device, and
wherein the supply mode determination unit determines the executable mode at the second output terminal based on a difference value obtained by subtracting the power, which is output through the first output terminal, from the power supplied from the power supply.

4. The power supply device of claim 3, wherein the supply mode determination unit determines the battery charging mode and the constant power supply mode as the executable mode when the difference value is greater than the predetermined reference power, and determines only the battery charging mode as the executable mode when the difference value is smaller than the predetermined reference power.

5. The power supply device of claim 1, wherein the output terminal includes a plurality of output terminals, and
wherein the supply mode determination unit determines a battery charging mode and a constant power supply mode as the executable mode, when a value obtained by dividing the power supplied from the power supply by the number of the output terminal is greater than predetermined reference power, and determines only the battery charging mode as the executable mode, when the value obtained by dividing the power supplied from the power supply by the number of the output terminal is smaller than the predetermined reference power.

6. The power supply device of claim 1, wherein, when the electronic device is in a battery type, the power supply standard of the electronic device includes a standard voltage, and
wherein the transformer unit transmits battery charging power having the standard voltage and a battery supply current calculated based on the standard voltage, through the output terminal.

7. The power supply device of claim 6, wherein the output type analysis unit derives a maximum supply current by dividing the power supplied from the power supply by the standard voltage, and sets a smaller value among the maximum supply current and a predetermined reference supply current to the battery supply current.

8. The power supply device of claim 1, wherein, when the electronic device is in a constant power type, the power supply standard of the electronic device includes a standard voltage and a standard current, and
wherein the transformer unit transmits battery charging power having the standard voltage and the standard current through the output terminal.

9. A power supply method performed by a power supply device connected to a power supply, the method comprising:
determining, by the power supply device, an executable mode among a battery charging mode and a constant power supply mode based on power supplied from the power supply;
connecting, by the power supply device, to an electronic device;
receiving, by the power supply device, a power supply type and a power supply standard of the electronic device from the electronic device; and
transforming, by the power supply device, the power supplied from the power supply based on the power supply type and the power supply standard and transmitting the transformed power to the electronic device,
wherein the determining of the executable mode includes:
determining the battery charging mode and the constant power supply mode as the executable mode when the power supplied from the power supply is greater than predetermined reference power; and
determining only the battery charging mode as the executable mode when the power supplied from the power supply is smaller than the predetermined reference power.

10. A computer-readable recording medium storing a program combined with a computer being a piece of hardware to execute a method in claim 9.
